(19) United States
(12) Patent Application Publication
(10) Pub. No.: US 2006/0225937 A1
(43) Pub. Date: Oct. 12, 2006

(54) Motorcycle throttle thumbscrew lever

(76) Inventor: Anthony Lemoine, Roswell, NM (US)

Correspondence Address: ANTHONY LEMOINE, 2302 CORNELL DRIVE, ROSWELL, NM, 88203, US

(21) Appl. No.: 11/006,220

(22) Filed: Mar. 16, 2005

(51) Int. Cl. B62K 11/00

(52) U.S. Cl. 180/219

(57) ABSTRACT

The thumbscrew on a motorcycle is designed to hold the throttle in a fixed position to maintain the desired RPM's. The thumbscrews come in several designs and are flush or near flush with the handlebar grip. This lever adjusts to fit most designs. It is a device that resembles a small wrench. The lever is attached to the existing thumbscrew and acts as an extension enabling the rider to easily access the thumbscrew and adjust the throttle as desired making the use of the thumbscrew safer.

### BACKGROUND OF INVENTION

Technical Field invention. The thumbscrews are found on the throttle control handlebar grips of some models of motorcycles and their function is to fix a motorcycle's engine idle speed. The thumbscrews function by fixing the handlebar grip in a given position so that a constant idle speed is achieved. Such thumbscrews vary in design. Some are in the form of a simple screw with a knurled head to facilitate gripping the screw while turning it. Those on many Harley-Davidson™ motorcycles have a star-shaped head.

In all of the designs, the thumbscrew is difficult to turn while wearing gloves and in many other situations where it is difficult to turn or otherwise manipulate the thumbscrew. Sometimes, the thumbscrew is engaged while the motorcycle is moving. In those situations, the inability to turn the screw to release the throttle grip and slow the engine speed could be considered hazardous to the rider. This invention is designed to make the thumbscrew more accessible to the rider.

### BRIEF SUMMARY OF INVENTION

The existing thumbscrew on motorcycles is difficult to access as it lays flush or almost flush on the throttle handlebar grip. Should the rider of the motorcycle need to adjust this screw while the motorcycle is being ridden or in order to set an idle speed to warm-up the bike, he/she is unable to reach it without creating a hazardous situation. The present invention extends the existing thumbscrew so that it can be manipulated without having to get under or beside the bike in order to do so.

### DESCRIPTION OF DRAWINGS

It should be noted that what is meant by the ‘top’ of the lever is the side to which the mating sections opening faces. The ‘bottom’ of the lever is designated as the side opposite the opening. FIG. 1 shows the preferred embodiment of the present invention a viewed from below. Lever 20 attaches to the thumbscrew 28 which is mounted on the motorcycle handlebar 42. Visible are handle 22 and the mating section 24 of lever 20. In the preferred embodiment, mating section 24 is placed on the head of the thumbscrew 28 so that the center planar face 30 faces down the length of the thumbscrew 28 toward motorcycle handlebar 42.

FIG. 2 shows lever 20 comprising handle 22, mating section 24, and adjustment means 26. In the preferred embodiment, adjustment means 26 is an adjustment screw. Other adjustable fasteners may be used such as a spring-loaded fasteners and other adjustable ad secure fasteners know in the art. Adjustment screw 26 stays fixed in the desired position using any of the conventional means known in the art. Mating section 25 comprises an opening 36 defined by center planar face 30, aft-end planar face 32, and fore-end planar face 34. Adjustment means 26 insets through the fore end of mating section 24 and fore-end planar face 34. In the preferred embodiment, aft-end face 32 is textured to enhance the gripping characteristic of lever 20. The texturing is preferable in the form of serrations. Handle 22 also is preferable textured to offer a better surface for the rider to grip. For better clearance and to minimize the potential for lever 20 to be obstructed by other components on the motorcycle handlebar, the portion of the handle 22 nearest mating section 24 is preferable narrower than the end portion of handle 22 that is gripped or touched by the rider's thumb.

FIG. 3 is a front view of lever 20 and depicts mating section 24 and the head of adjustment screw 25.

FIG. 4 is a rear view of lever 20 and so depicts handle 22 and a portion of the aft portion of mating section 24.

FIG. 5 shows a bottom view of lever 20 with mating section 24, handle 22, and a portion of adjustment screw 26.

FIG. 6 shows a top view of lever 20, and visible are mating section 24, handle 22, center planar face 30, and adjustment screw 26.

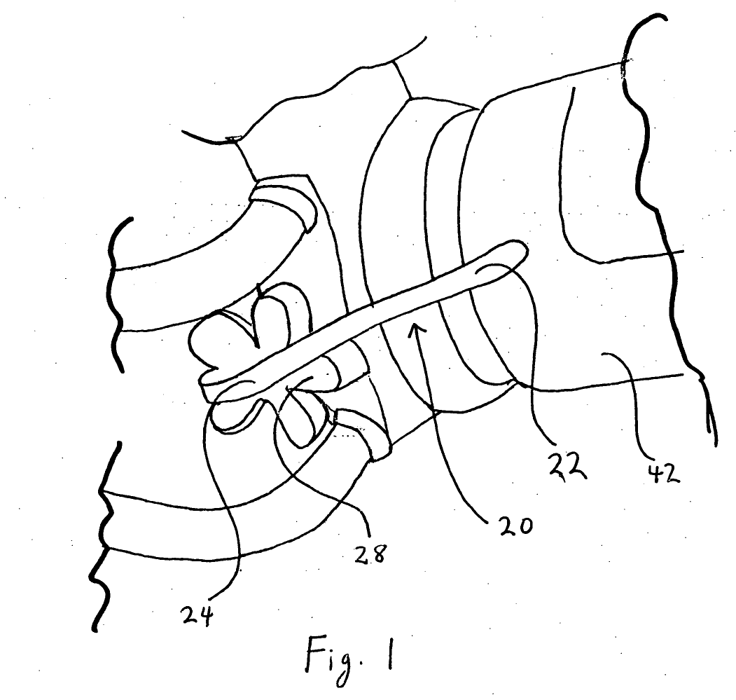

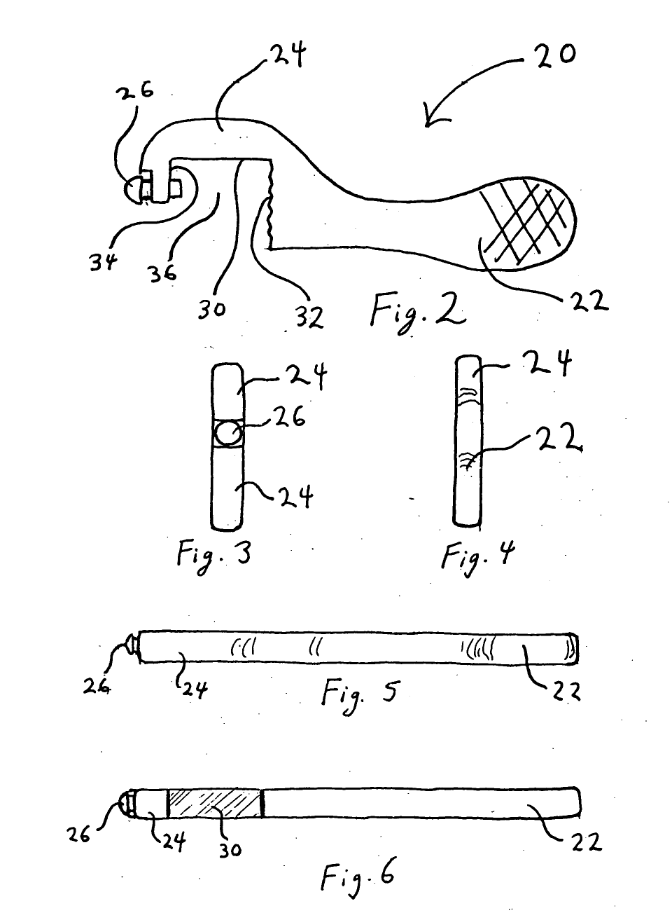

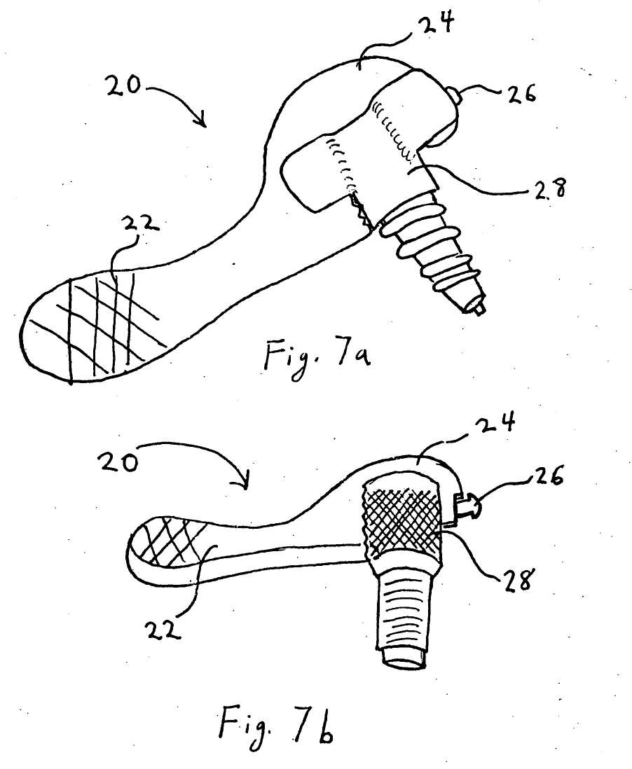

In the preferred embodiment, as can be seen in FIGS. 3, 4, 5 and 6, the thickness of handle 22 and mating section 24 is consistent throughout although the thickness can vary. In the preferred embodiment, the thickness of handle 22 and mating section 24 is preferable ⅛ inch.

The opening of mating section 24 and thus the length of center planar face 30 is of sufficient length to fit over a thumbscrew. In the preferred embodiment, the length of the center planar face 30 is preferable approximately 7/16 inch. In the preferred embodiment, the length of aft-end planar face 32 is approximately 8/16 inch, and the length of fore-end planar face 34 is approximately 7/32 inch.

FIG. 7a shows the preferred embodiment of lever 20 attached to thumbscrew 28 comprising a star shaped design. FIG. 7b shows a preferred embodiment of lever 20 attached to thumbscrew 28 comprising a knurled head. Adjustment screw 26 is turned or otherwise adjusted to provide a tight fit between lever 20 and thumbscrew 28.

The lever of the present invention may comprise any rigid material capable of accommodating the amount of torque required to turn a thumbscrew. The material may comprise a rigid plastic, a hard metal, or any other rigid material. The preferred material is steel or aluminum.

### DESCRIPTION OF INVENTION

Invention is a lever whose handle is approximately between ¼ inch and 1 inch, preferable approximately ½ inch at it's widest point. The overall length is between 1 ½ inch and 2 inches, preferable 1 ¾ inches. The dimensions of the opening of the mating portion of the lever may vary as required to fit any thumbscrew design. The lever is preferable made of a rigid material such as steel or aluminum. The thumbscrew on motorcycles is located on the underside of the handlebar. The thumbscrew lays flush or near flush with the handlebar grip. This invention is attached to said thumbscrew via opening the mating portion of the lever with an ordinary screwdriver. The invention is placed over or on top of the existing thumbscrew and the mating portion of the lever is then tightened onto the existing thumbscrew with an ordinary screwdriver. The lever should be tightened to a degree where ordinary riding of the motorcycle does not loosen it. The lever can be removed and re-attached as desired by the rider. Attachment of this lever enables the rider to access the thumbscrew in order to safely set the throttle of the motorcycle to a set idling speed.

1. The present invention comprises an extension for a thumbscrew used to fix a motorcycle's engine speed by stabilizing the motorcycle's throttle control handlebar grip in a given position. This invention is in the form of a lever. The present invention is attached to the existing screw that is present on most motorcycles and makes the existing thumbscrew easily accessible to the rider of said motorcycle. Use of the lever assists the motorcycle rider in controlling the desired rotation of the thumbscrew and the engine idle speed of the motorcycle. The present invention can be used to maintain idle speed of a motorcycle's engine in order to warm-up the engine prior to use. The lever extension of this invention offers good tactile sensation to a motorcycle rider and offers the rider a better reach so that the rider can easily affect the handlebar-mounted throttle control thumbscrew. The dimensions of the lever are such that obstructions with other handlebar components are eliminated or minimized. The lever is easy to use, stays attached even during severe riding conditions and fits all thumbscrews, regardless of design.
